(19) United States
(12) Patent Application Publication
(10) Pub. No.: US 2014/0069033 A1
(43) Pub. Date: Mar. 13, 2014

(54) FLORA BARRIER MEMBER FOR A GRAVE MARKER

(71) Applicant: DANIEL MORNING, Letterkenny (IE)

(72) Inventor: DANIEL MORNING, Letterkenny (IE)

(21) Appl. No.: 13/608,016

(22) Filed: Sep. 10, 2012

(51) Int. Cl. E04H 13/00; B32B 3/02; A01P 13/00; C08F 136/06; A01N 25/34; E04G 21/00; B32B 3/00

(52) U.S. Cl. 52/103; 52/741.11; 428/131; 428/57; 526/335; 504/116.1

(57) ABSTRACT

This invention relates to a flora barrier member for a grave marker, the combination of a flora barrier member and a grave marker, and a method of erecting a grave marker. Many cemeteries have banned the use of temporary grave markers as they are prone to damage and increase the amount of time required to maintain the cemetery. This is due to the fact that extra time must be taken to remove the grass and weeds in the vicinity of the base of the grave marker. The present invention provides a flora barrier member that prevents grass or weed growth in this area. The flora barrier member is simple to construct and install and will allow the use of temporary grave markers in most cemeteries.

### BACKGROUND OF THE INVENTION

This invention relates to a flora barrier member for a grave marker, the combination of a flora barrier member and a grave marker, and a method of erecting a grave marker.

It is quite common for a headstone not to be in place at the graveside when an individual is being buried. In some cases, it is desirable to allow the ground in the vicinity of the grave to settle before erecting the headstone to obviate the possibility of the headstone moving once erected due to subsidence. In other cases, there will be insufficient time to select an appropriate headstone and/or engrave the headstone with the details of the deceased and the headstone is often erected some time after the burial. Before the headstone is put in place, it is desirable to place a temporary grave marker at the graveside. These temporary grave markers enable mourners and cemetery workers to identify the grave of a particular deceased individual until such time as the headstone is put in place.

The temporary grave markers typically comprise a body having a face for indicia to be printed or engraved thereon and a stake that may be driven into the ground and used to support the body above ground. Generally speaking, temporary grave markers are provided in a variety of different shapes and sizes however these may be broadly categorised into two different types of temporary grave markers, so-called flush-mounted grave markers and pedestal grave markers. Flush-mounted grave markers are effectively a tablet that lies flat on the ground and in order to read the grave marker, it is necessary to be standing practically directly above the grave marker. Pedestal grave markers tend to comprise a substantially upright member such as a cross or a plaque supported on one or more stakes that are driven into the ground and support the plaque or other indicia bearing face of the grave marker above ground. The pedestal grave markers are often preferred due to the fact that it is usually not necessary to stand in the immediate vicinity of the grave marker in order to read the grave marker and therefore this type of grave marker facilitates the quick location of a grave.

Unfortunately, temporary grave markers, and pedestal-type grave markers in particular, are not allowed in many cemeteries. The reason why many cemeteries do not allow temporary grave markers is that they increase the cost of maintenance of the cemetery. It is usually very difficult and time consuming to cut the grass and remove any weeds that grow in the area surrounding the temporary grave marker. This is because it is difficult to manoeuvre a lawnmower or strimmer accurately around the temporary grave marker without damaging the temporary grave marker. Therefore, it takes longer to remove grass and weeds from the vicinity of the base of the temporary grave marker which increases the cost of upkeep of the cemetery. Furthermore, temporary grave markers are often damaged in the process of cutting the grass and weeds surrounding the base of the temporary grave marker. This can cause upset to the bereaved and represents an additional cost to the cemetery management as they must repair or replace the damaged temporary grave markers. Finally, broken pieces of temporary grave markers cannot be left lying around as they are unsightly and represent a hazard to the bereaved and workers in the cemetery.

The present invention provides a solution to many if not all of these issues and allows the use of temporary grave markers in cemeteries.

### SUMMARY OF THE INVENTION

According to the invention there is provided a flora barrier membrane for a grave marker, the grave marker comprising a body having a footprint with a first fore and aft depth dimension and a first side to side width dimension, the flora barrier membrane comprising a barrier member having a footprint with a second fore and aft depth dimension greater than the first fore and aft depth dimension of the grave marker and a second side to side width dimension greater than the first side to side width dimension of the grave marker, and in which, the flora barrier membrane, in use, prevents passage of flora therethrough and rests on the ground substantially surrounding the grave marker with the footprint of the flora barrier membrane covering the footprint of the grave marker body and extending outwardly beyond the footprint of the grave marker body.

By having such a flora barrier membrane, the growth of grass and weeds, hereinafter referred to simply as flora, will be prevented in the vicinity of the temporary grave marker. This will significantly simplify the maintenance of the cemetery and reduce the time required to maintain the cemetery. The barrier member will cover an area of ground overlapping with the footprint of the grave marker and will extend beyond the footprint of the grave marker so that it is no longer necessary to get a lawnmower or a strimmer in beneath overhanging parts of a temporary grave marker in and around the base of the grave marker to cut grass and weeds from this area. As well as speeding up maintenance, this will reduce the likelihood of damage being caused to the temporary grave marker.

In one embodiment of the invention there is provided a flora barrier membrane for a grave marker in which the barrier member is constructed from a pierceable material to allow a stake of a grave marker to pass therethrough. Grave markers come in a variety of shapes and sizes, often with one or more stakes for supporting the grave markers. By making the barrier member from a pierceable material, this will allow a single construction of flora barrier membrane to be used with a large number of disparate types of grave markers.

In one embodiment of the invention there is provided a flora barrier membrane for a grave marker in which the barrier member comprises a grave marker stake receiving aperture dimensioned to receive a grave marker stake therethrough. This is seen as a useful alternative or addition to providing a barrier member made from a pierceable material. By having an aperture for the stake, the barrier member can be installed quickly and with ease.

In one embodiment of the invention there is provided a flora barrier membrane for a grave marker in which the barrier member is constructed from a plurality of parts that are dimensioned to be arranged in a configuration surrounding a stake of a grave marker, each of the plurality of parts abutting against another of the plurality of parts. Again, this is seen as a useful alternative to providing a barrier member constructed from a pierceable material.

In one embodiment of the invention there is provided a flora barrier membrane for a grave marker in which a surface of the barrier member which, in use, faces the ground, is provided with a herbicide coating. By providing the surface of the barrier member with a herbicide coating, growth of grass and weeds underneath the barrier member in the vicinity of the grave marker can be actively discouraged.

In one embodiment of the invention there is provided a flora barrier membrane for a grave marker in which the barrier member is constructed from a flexible sheet of material. By providing the barrier member as a flexible sheet of material, the barrier member will be easily transportable as well as being suitable for laying on uneven ground.

In one embodiment of the invention there is provided a flora barrier membrane for a grave marker in which the barrier member is constructed from a rubber material.

In one embodiment of the invention there is provided a flora barrier membrane for a grave marker in which the barrier member is constructed from a plastic material.

In one embodiment of the invention there is provided a combination, a grave marker comprising a body having a footprint with a first fore and aft depth dimension and a first side to side width dimension and a flora barrier membrane for the grave marker, the flora barrier membrane comprising a barrier member having a footprint with a second fore and aft depth dimension greater than the first fore and aft depth dimension of the grave marker and a second side to side width dimension greater than the first side to side width dimension of the grave marker, and in which, the flora barrier membrane, in use, prevents passage of flora therethrough and rests on the ground substantially surrounding the grave marker with the footprint of the flora barrier membrane covering the footprint of the grave marker body and extending outwardly beyond the footprint of the grave marker body. It is seen as useful to provide both the temporary grave marker and the flora barrier membrane together.

In one embodiment of the invention there is provided a combination of grave marker and flora barrier membrane in which the grave marker comprises a stake for insertion into the ground and for supporting the body above the ground.

In one embodiment of the invention there is provided a combination of grave marker and flora barrier membrane in which the barrier member is provided with an aperture for throughpassage of the stake of the grave marker.

In one embodiment of the invention there is provided a combination of grave marker and flora barrier membrane in which the barrier member is mounted on the stake intermediate the stake's ends. This is seen as particularly useful as the barrier member will be in position ready to lie on the ground overlying and surrounding the footprint of the grave marker. The barrier member can also be placed at a point along the stake that will inform the individual inserting the stake of the correct amount by which the stake must be inserted into the ground and will ensure that the grave markers of a particular type in a cemetery are at a uniform height.

In one embodiment of the invention there is provided a combination of grave marker and flora barrier membrane in which the barrier member is constructed from a pierceable material to allow a stake of the grave marker to pass therethrough.

In one embodiment of the invention there is provided a combination of grave marker and flora barrier membrane in which the barrier member is constructed from a plurality of parts that are dimensioned to be arranged in a configuration surrounding the stake of a grave marker, each of the plurality of parts abutting against another of the plurality of parts.

In one embodiment of the invention there is provided a combination of grave marker and flora barrier membrane in which a surface of the barrier member which, in use, faces the ground, is provided with a herbicide coating.

In one embodiment of the invention there is provided a combination of grave marker and flora barrier membrane in which the barrier member is constructed from a flexible sheet of material.

In one embodiment of the invention there is provided a method of erecting a grave marker comprising the steps of:
providing a grave marker comprising a body having a footprint with a first fore and aft depth dimension and a first side to side width dimension;
providing a flora barrier membrane, the flora barrier membrane comprising a barrier member having a footprint with a second fore and aft depth dimension greater than the first fore and aft depth dimension of the grave marker and a second side to side width dimension greater than the first side to side width dimension of the grave marker, and in which, the flora barrier membrane, in use, prevents passage of flora therethrough;
placing the barrier member on the ground; and
placing the grave marker on the barrier member in a position with the barrier member footprint substantially overlaying and extending outwardly beyond the footprint of the grave marker body.

This is seen as a useful method of erecting the grave marker that will prevent weeds and grass growing in the immediate vicinity of the base of the grave marker and will simplify future maintenance of the cemetery in which the grave marker is erected.

In one embodiment of the invention there is provided a method of erecting a grave marker in which the grave marker has a stake for supporting the body above ground and the step of placing the grave marker on the flora barrier further comprises passing the stake through the barrier member into the ground.

In one embodiment of the invention there is provided a method of erecting a grave marker in which the stake is passed through an aperture in the barrier member.

In one embodiment of the invention there is provided a method of erecting a grave marker in which the barrier member comprises a plurality of barrier member parts and in which instead of placing the barrier member on the ground and thereafter placing the grave marker on the barrier member, the grave marker is first placed on the ground and the plurality of barrier member parts are thereafter arranged on the ground around the grave marker surrounding the barrier member.

### BRIEF DESCRIPTION OF THE DRAWINGS

The invention will now be more clearly understood from the following description of some embodiments thereof given by way of example only with reference to the accompanying drawings, in which:

FIG. 1 is a perspective view of a temporary grave marker and flora barrier membrane according to the invention;

FIG. 2 is a top plan view of the temporary grave marker of FIG. 1;

FIG. 3 is a perspective view of an alternative embodiment of temporary grave marker and flora barrier membrane according to the invention;

FIG. 4 is a top plan view of the temporary grave marker of FIG. 3;

FIG. 5 is a perspective view of another alternative embodiment of temporary grave marker and flora barrier membrane according to the invention;

FIG. 6 is a top plan view of the temporary grave marker of FIG. 5;

FIG. 7 is a perspective view of a grave marker and flora barrier membrane according to the invention; and

FIG. 8 is a top plan view of the temporary grave marker of FIG. 7.

### DESCRIPTION OF THE PREFERRED EMBODIMENTS

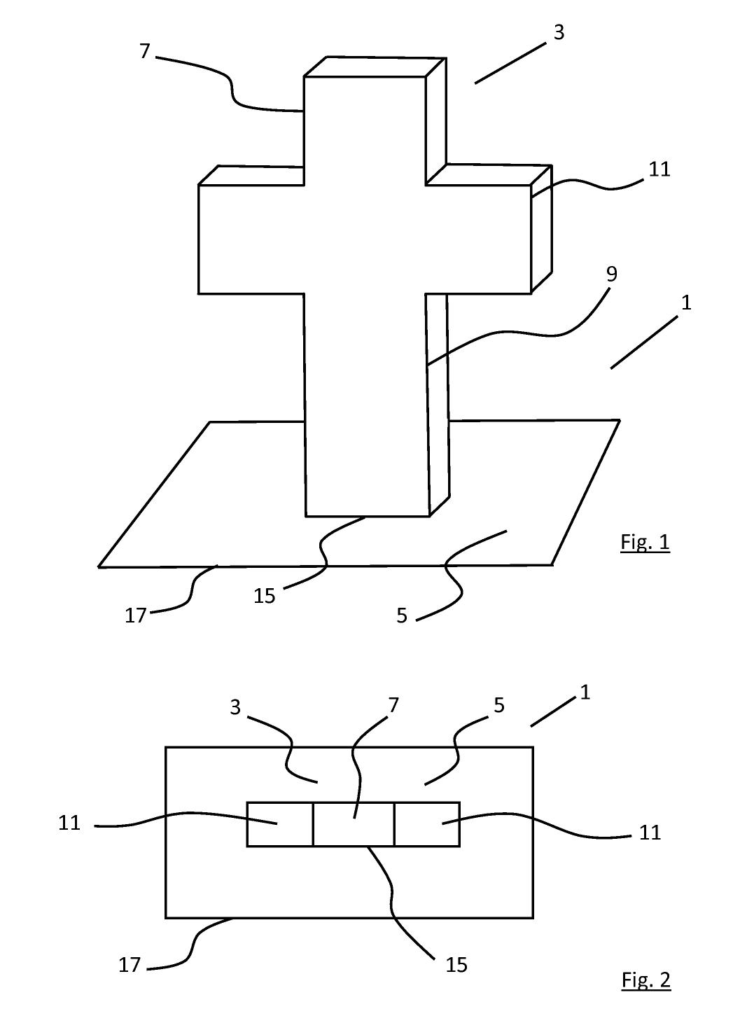

Referring to FIG. 1, there is shown a perspective view of a flora barrier membrane, indicated generally by the reference numeral 1, for a grave marker, in this case a cross-shaped temporary grave marker 3. The flora barrier membrane comprises a barrier member 5 that prevents passage of flora therethrough and rests on the ground substantially surrounding the grave marker 3. The grave marker 3 is a cross-shaped temporary grave marker with an upright portion 7 including a stake 9 for insertion into the ground and a lateral cross bar 11 intermediate the ends of the upright portion 7. The footprint 13 of the grave marker is shown in dotted outline in FIG. 1. The barrier member 5 comprises a matt that substantially surrounds the base of the stake 9, overlaying the footprint 13 of the grave marker 3 and extending outwardly therefrom. In this way, it is not necessary to maneuver a lawnmower or a strimmer underneath the lateral cross bar 11 as growth of grass and weeds in this area will be prevented. The stake 9 passes through a stake receiving aperture 15 in the barrier member and is inserted into the ground in the known manner.

Referring to FIG. 2, there is shown a plan view of the flora barrier membrane shown in FIG. 1. It can be seen that the footprint of the barrier member 5, represented by peripheral edge 17 of the barrier member, extends beyond the footprint (not shown) of the temporary grave marker 3. In the embodiment shown, the barrier member is substantially rectangular in shape and this will allow the efficient use of a lawnmower in the vicinity of the barrier member to cut the grass and weeds that surround the barrier member.

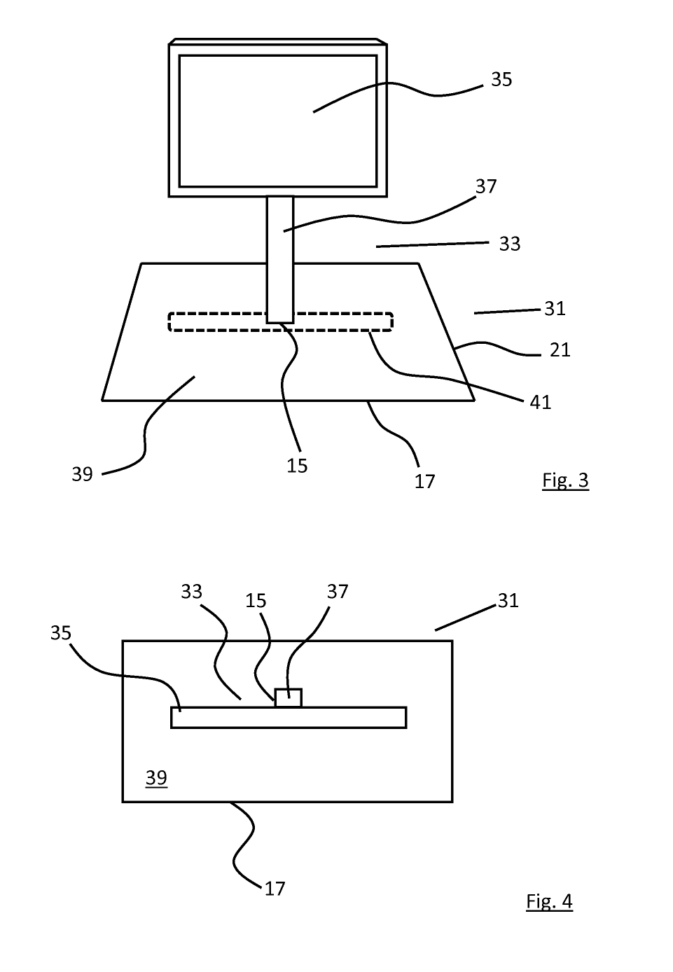

Referring to FIGS. 3 and 4, there is shown an alternative embodiment of flora barrier membrane according to the present invention, indicated generally by the reference numeral 31, and a temporary grave marker according to the present invention indicated generally by the reference numeral 33. For reasons of simplicity, like parts have been given the same reference numeral as before. The grave marker 33 comprises a plaque 35 mounted on a stake 37. The flora barrier membrane comprises a barrier member 39 as before however in this instance the barrier member is not a matt but instead is a rigid plate that is placed on the ground. The rigid plate has an aperture 15 for throughpassage of the stake 37. The footprint of the grave marker is shown in dotted outline 41 in FIG. 3.

Referring specifically to FIG. 4, the footprint 17 of the barrier member 39 overlays and extends outwardly beyond the footprint of the grave marker. Once again, the barrier member 39 is substantially rectangular in shape and this will allow the efficient use of a lawnmower in the vicinity of the barrier member to cut the grass and weeds that surround the barrier member.

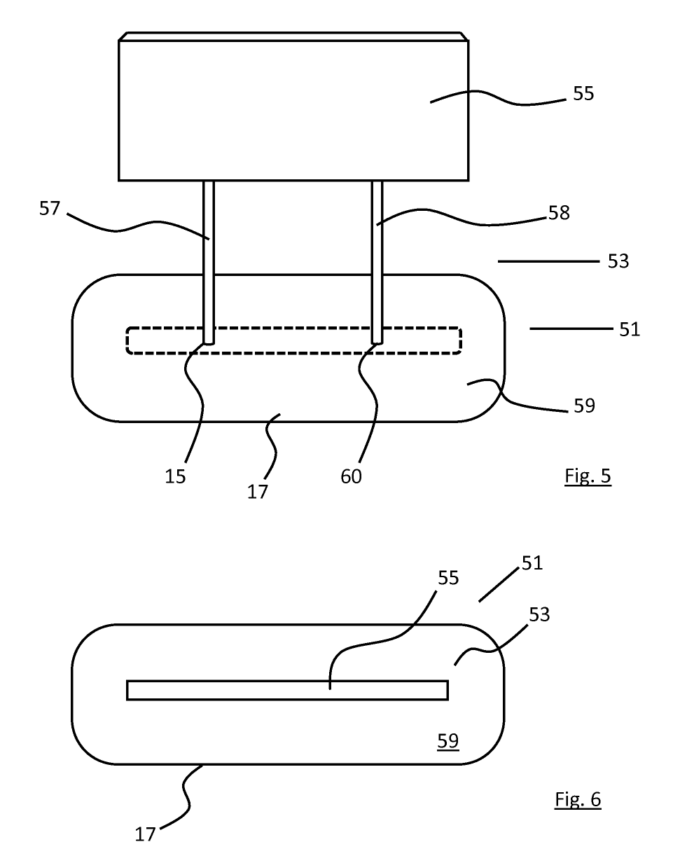

Referring to FIGS. 5 and 6, there is shown another alternative embodiment of flora barrier membrane according to the present invention, indicated generally by the reference numeral 51, and a temporary grave marker according to the present invention indicated generally by the reference numeral 53. For reasons of simplicity, like parts have been given the same reference numeral as before. The grave marker 53 comprises a plaque 55 mounted on a pair of stakes 57, 58. The flora barrier membrane comprises a barrier member 59 as before however in this instance the barrier member is constructed from a flexible material, in this case rubber. The rubber material forming the barrier member 59 has a pair of apertures 15, 60 for throughpassage of the stakes 57, 58 respectively. The footprint of the grave marker is shown in dotted outline 61 in FIG. 5.

Referring specifically to FIG. 6, the footprint 17 of the barrier member 59 overlays and extends outwardly beyond the footprint of the grave marker. In the embodiment shown, the barrier member 59 is substantially racetrack-shaped and this will allow the efficient use of a lawnmower or strimmer in the vicinity of the barrier member to cut the grass and weeds that surround the barrier member. Instead of providing apertures 15, 60 for the stakes 57, 58, the barrier member 59 could be constructed from a pierceable material by having a suitable thickness or shore hardness of the rubber in one or more places or throughout that would allow the stake to be pierced therethrough. Alternatively, other materials other than rubber such as a woven fabric could be used instead.

In use, in order to construct the temporary grave marker and flora barrier membrane as shown in any of FIGS. 1 to 6, the barrier member 5, 39, 59 is placed on the ground in the desired location. If the barrier member 5, 39, 59 is provided with one or more apertures, the stake or stakes of the grave marker 3, 33, 53 are inserted through the stake receiving apertures in the barrier member 5, 39, 59 and driven into the ground. Alternatively, if there is no aperture provided and the barrier member 5, 39, 59 is a pierceable material, the stake is driven through the pierceable material into the ground. Grass and weeds will not grow through the barrier member 5, 39, 59 thereby ensuring that the area surrounding the stake inside the footprint of the barrier member 5, 39, 59 is free of grass and weeds.

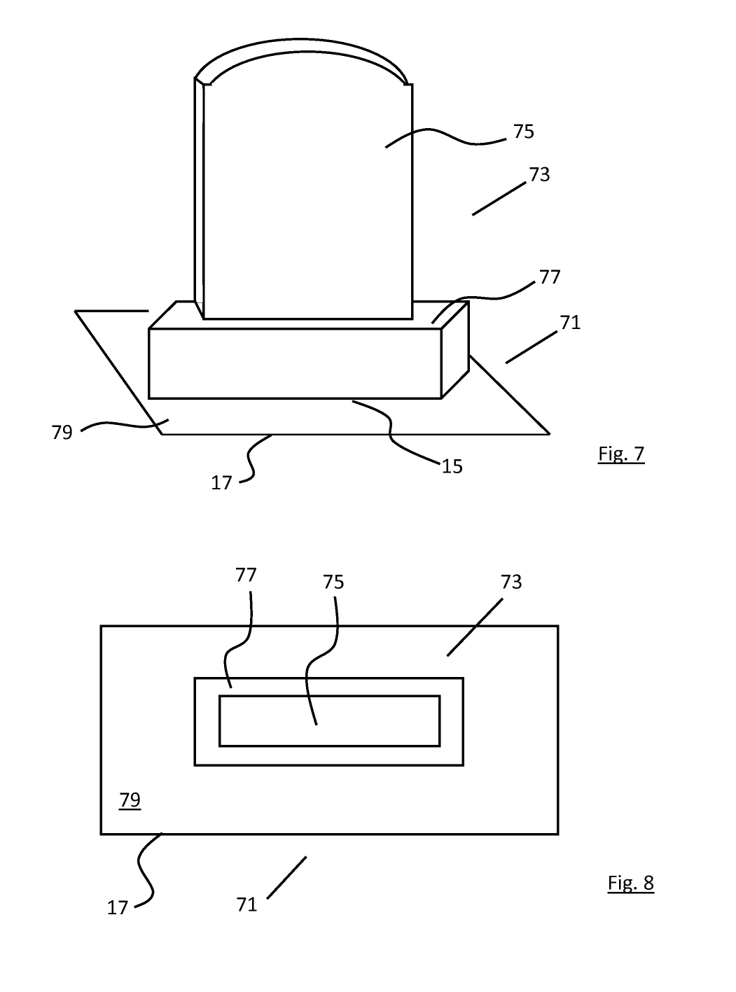

Referring to FIGS. 7 and 8, there is shown an alternative embodiment of flora barrier membrane according to the present invention, indicated generally by the reference numeral 71, and a permanent grave marker, in this case a tombstone, according to the present invention indicated generally by the reference numeral 73. For reasons of simplicity, like parts have been given the same reference numeral as before. The grave marker 73 comprises a substantially upright tablet 75 mounted on a plinth 77, otherwise commonly referred to as a base. The flora barrier membrane comprises a barrier member 79 as before however in this instance the barrier member is provided with a significantly larger aperture 15. By having the larger aperture 15, the barrier member 79 may be draped over the tablet 75 and the plinth 77 so that the barrier member 79 surrounds the plinth 77 and rests on the ground. The footprint of the grave marker corresponds with the footprint of the plinth in this instance as the plinth is the widest and deepest part of the grave marker.

Referring specifically to FIG. 8, the footprint 17 of the barrier member 79 overlays and extends outwardly beyond the footprint of the grave marker 73. Once again, the barrier member 79 is substantially rectangular in shape and this will allow the efficient use of a lawnmower or strimmer in the vicinity of the barrier member to cut the grass and weeds that surround the barrier member. Indeed, the construction shown could obviate the need for the use of a strimmer altogether which may speed up the maintenance of the cemetery.

It will be understood that various modifications could be used without departing from the spirit of the invention or the scope of the appended claims. For example, in the embodiments shown, there are provided one or two apertures to receive one or two stakes however more apertures and stakes could be provided if desired. Furthermore, the material chosen for the barrier member may be rubber, plastic, metal or a fabric material. The barrier member may have apertures or may be pierceable so that it can be penetrated by one or more stakes. The grave markers shown are pedestal type grave markers however there is merit to using the embodiments of flora barrier members with flush-mounted grave markers also and this is readily envisaged. In the embodiments shown, the barrier members are either rectangular or racetrack shaped however other shapes of barrier member are possible and readily envisaged. What is important is that the barrier member forms a close or tight fit with the stake as well as overlaying and extending beyond the footprint of the grave marker. Instead of providing a single sheet of material, the barrier member could be provided in a number of parts that may be connected together or brought into engagement with each other around the stake or stakes of the grave marker. Indeed, the barrier could be formed integrally with the grave marker and could be fixed or slidably mounted intermediate the ends of one or more stakes of the grave marker.

In addition to the above, the underside of the barrier members 5, 39, 59, 79 could be coated or treated with a herbicide to prevent grass or weed growth in the vicinity of the stake and inside the footprint of the barrier members 5, 39, 59, 79. It is envisaged that a temporary or permanent grave marker may be sold together with a flora barrier membrane. The flora barrier membrane may be already mounted in position on the grave marker if desired.

In this specification, the terms “comprise, comprises, comprised and comprising” and the terms “include, includes, included and including” are all deemed totally interchangeable and should be afforded the widest possible interpretation.

The invention is in no way limited to the embodiments hereinbefore described but may be varied in both construction and detail within the scope of the claims.

1. A flora barrier membrane for a grave marker, the grave marker comprising a body having a footprint with a first fore and aft depth dimension and a first side to side width dimension, the flora barrier membrane comprising a barrier member having a footprint with a second fore and aft depth dimension greater than the first fore and aft depth dimension of the grave marker and a second side to side width dimension greater than the first side to side width dimension of the grave marker, and in which, the flora barrier membrane, in use, prevents passage of flora therethrough and rests on the ground substantially surrounding the grave marker with the footprint of the flora barrier membrane covering the footprint of the grave marker body and extending outwardly beyond the footprint of the grave marker body.

2. The flora barrier membrane for a grave marker as claimed in claim 1 in which the barrier member is constructed from a pierceable material to allow a stake of a grave marker to pass therethrough.

3. The flora barrier membrane for a grave marker as claimed in claim 1 in which the barrier member comprises a grave marker stake receiving aperture dimensioned to receive a grave marker stake therethrough.

4. The flora barrier membrane for a grave marker as claimed in claim 1 in which the barrier member is constructed from a plurality of parts that are dimensioned to be arranged in a configuration surrounding a stake of a grave marker, each of the plurality of parts abutting against another of the plurality of parts.

5. The flora barrier membrane for a grave marker as claimed in claim 1 in which a surface of the barrier member which, in use, faces the ground, is provided with a herbicide coating.

6. The flora barrier membrane for a grave marker as claimed in claim 1 in which the barrier member is constructed from a flexible sheet of material.

7. The flora barrier membrane for a grave marker as claimed in claim 6 in which the barrier member is constructed from a rubber material.

8. The flora barrier membrane for a grave marker as claimed in claim 6 in which the barrier member is constructed from a plastic material.

9. In combination, a grave marker comprising a body having a footprint with a first fore and aft depth dimension and a first side to side width dimension and a flora barrier membrane for the grave marker, the flora barrier membrane comprising a barrier member having a footprint with a second fore and aft depth dimension greater than the first fore and aft depth dimension of the grave marker and a second side to side width dimension greater than the first side to side width dimension of the grave marker, and in which, the flora barrier membrane, in use, prevents passage of flora therethrough and rests on the ground substantially surrounding the grave marker with the footprint of the flora barrier membrane covering the footprint of the grave marker body and extending outwardly beyond the footprint of the grave marker body.

10. The combination of grave marker and flora barrier membrane as claimed in claim 9 in which the grave marker comprises a stake for insertion into the ground and for supporting the body above the ground.

11. The combination of grave marker and flora barrier membrane as claimed in claim 10 in which the barrier member is provided with an aperture for throughpassage of the stake of the grave marker.

12. The combination of grave marker and flora barrier membrane as claimed in claim 11 in which the barrier member is mounted on the stake intermediate the stake's ends.

13. The combination of grave marker and flora barrier membrane as claimed in claim 10 in which the barrier member is constructed from a pierceable material to allow a stake of the grave marker to pass therethrough.

14. The combination of grave marker and flora barrier membrane as claimed in claim 10 in which the barrier member is constructed from a plurality of parts that are dimensioned to be arranged in a configuration surrounding the stake of a grave marker, each of the plurality of parts abutting against another of the plurality of parts.

15. The combination of grave marker and flora barrier membrane as claimed in claim 9 in which a surface of the barrier member which, in use, faces the ground, is provided with a herbicide coating.

16. The combination of grave marker and flora barrier membrane as claimed in claim 9 in which the barrier member is constructed from a flexible sheet of material.

17. A method of erecting a grave marker comprising the steps of:
providing a grave marker comprising a body having a footprint with a first fore and aft depth dimension and a first side to side width dimension;
providing a flora barrier membrane, the flora barrier membrane comprising a barrier member having a footprint with a second fore and aft depth dimension greater than the first fore and aft depth dimension of the grave marker and a second side to side width dimension greater than the first side to side width dimension of the grave marker, and in which, the flora barrier membrane, in use, prevents passage of flora therethrough;
placing the barrier member on the ground; and
placing the grave marker on the barrier member in a position with the barrier member footprint substantially overlaying and extending outwardly beyond the footprint of the grave marker body.

18. The method of erecting a grave marker as claimed in claim 17 in which the grave marker has a stake for supporting the body above ground and the step of placing the grave marker on the flora barrier further comprises passing the stake through the barrier member into the ground.

19. The method of erecting a grave marker as claimed in claim 18 in which the stake is passed through an aperture in the barrier member.

20. The method of erecting a grave marker as claimed in claim 17 in which the barrier member comprises a plurality of barrier member parts and in which instead of placing the barrier member on the ground and thereafter placing the grave marker on the barrier member, the grave marker is first placed on the ground and the plurality of barrier member parts are thereafter arranged on the ground around the grave marker surrounding the barrier member.
